(19) United States
(12) Patent Application Publication
(10) Pub. No.: US 2005/0069279 A1
(43) Pub. Date: Mar. 31, 2005

(54) Control device and method

(76) Inventors: Fumito Kuramochi, Kanagawa (JP); Michio Miyano, Kanagawa (JP); Takashi Yamamoto, Tokyo (JP); Kaoru Nara, Tokyo (JP); Takashi Hirose, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/494,624

(22) PCT Filed: Sep. 3, 2003
(86) PCT No.: PCT/JP03/11232

(30) Foreign Application Priority Data
Sep. 4, 2002 (JP) 2002-258352

(51) Int. Cl. H04N 5/76; G11B 27/00

(52) U.S. Cl. 386/46; 386/52

(57) ABSTRACT

A control device and control method are suitable for copying digital data between electronic devices connected to one another via a digital data bus. A digital broadcast receiver receives and decodes a digital broadcast signal, and outputs the resulting video signal to a display and the resulting audio signal to a speaker. The digital broadcast receiver also exchanges decoded video signals and audio signals with digital recorders/players that are connected to one another via an IEEE 1394 data bus. Further, the digital broadcast receiver controls a digital data copy operation that is performed among the digital recorders/players connected to the IEEE 1394 data bus.

### BACKGROUND OF THE INVENTION

The present invention relates to a control device and method, and more particularly, to a control device and method that are suitable for copying digital data between electronic devices connected via a digital data bus.

A method exists for communicating video data, audio data, and other digital data to a plurality of connected AV devices via a digital data bus, such as an IEEE (Institute of Electrical and Electronics Engineers) 1394 data bus (so-called i.LINK (trademark)) (this method is described, for instance, in Sony Corporation's “Application of IEEE 1394 High-Speed Digital Interface to AV Devices”, which was published by Japan Industrial Journal on Jan. 28, 2001).

Electronic devices connectable to the digital data bus include personal computers, television receivers, digital video cameras, hard disk recorders, digital VCRs (Video Cassette Recorders), digital broadcast receivers, and MD players. These electronic devices are hereinafter collectively referred to as digital recorders/players.

When digital data played by a digital recorder/player is to be recorded into another digital recorder/player via a digital data bus (that is, when digital data is to be copied), the user has to sequentially perform the steps in the flowchart shown in FIG. 1. The subsequent description assumes that an IEEE 1394 digital data bus is used.

In step S1, the user establishes a LINC (Logical Interface Connection) between the output plug on a digital recorder/player for playing digital data (hereinafter referred to as the player) and the input plug on a digital recorder/player for recording digital data (hereinafter referred to as the recorder).

In step S2, the user turns ON the player and recorder. In step S3, the user causes the recorder to start a recording operation. In step S4, the user causes the player to start a playback operation. In step S5, the user monitors the digital data copy operation until it ends.

When the digital data copy operation has ended, the user performs step S6 to stop the playback operation of the player. In step S7, the user stops the recording operation of the recorder. In step S8, the user turns OFF the player and the recorder. Performing the above steps copies the digital data from the player to the recorder.

However, the above sequence of steps cannot easily be performed by the user unless the user is familiar with the digital recorder/player operating procedures. Further, if the copy operation fails in the middle of the above sequence, it is impossible to directly determine its cause. Additionally, the user has to take the trouble to monitor the copy operation until it is completed.

### SUMMARY OF THE INVENTION

The present invention is made to solve the foregoing problems, and has for its object to enable the user to copy digital data between digital recorders/players connected to a digital data bus while saving the user from having to perform many operating steps.

A control device according to the present invention includes a monitoring section for monitoring data output from a first electronic device connected to a digital data bus, an association control section for controlling an association between the data output from the first electronic device and data input to a second electronic device connected to the digital data bus, a start control section for starting a digital data copy process in which data output from the first electronic device is copied to the second electronic device by starting a playback operation of the first electronic device and a recording operation of the second electronic device, a stop control section for stopping the playback operation of the first electronic device and the recording operation of the second electronic device, and a notification section for indicating a result of the digital data copy process.

As the above digital data bus, an IEEE 1394 data bus may be used.

The control device according to the present invention may further include a detection section for detecting an abnormality in at least one of the first and second electronic devices and aborting the copy process.

The above-mentioned notification section may also identify the abnormality detected by the detection section.

A control method according to the present invention includes monitoring data output from a first electronic device connected to a digital data bus, controlling an association between the data output from the first electronic device and data input to a second electronic device connected to the digital data bus, starting a digital data copy process in which data output from the first electronic device is copied to the second electronic device by starting a playback operation of the first electronic device and a recording operation of the second electronic device, stopping the playback operation of the first electronic device and the recording operation of the second electronic device, and indicating a result of the digital data copy process.

The control device and method according to the present invention control the association between the data output from a first electronic device and the data input to a second electronic device connected to a digital data bus, and start a digital data copy process in which data output from the first electronic device is copied to the second electronic device by starting a playback operation of the first electronic device and a recording operation of the second electronic device. Subsequently, the playback operation of the first electronic device and the recording operation of the second electronic device are stopped, and then the result of the digital data copy process is indicated.

### BRIEF DESCRIPTION OF THE DRAWINGS

FIG. 1 is a flowchart illustrating the steps that are performed by the user for copying digital data between digital recorders/players.

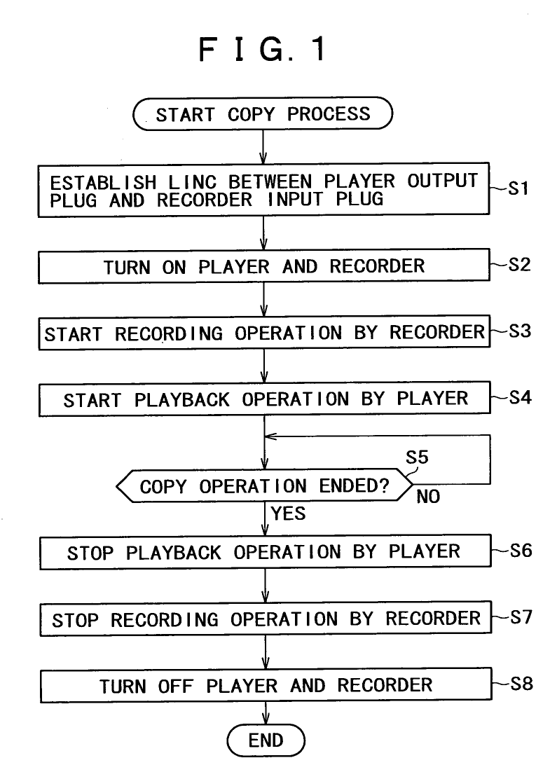

FIG. 2 is a block diagram illustrating a typical configuration of a digital broadcast receiver according to the present invention.

FIG. 3 is a flowchart illustrating how a copy control process is performed by a digital broadcast receiver.

FIG. 4 is a flowchart illustrating how a copy control process is performed by a digital broadcast receiver.

### DETAILED DESCRIPTION

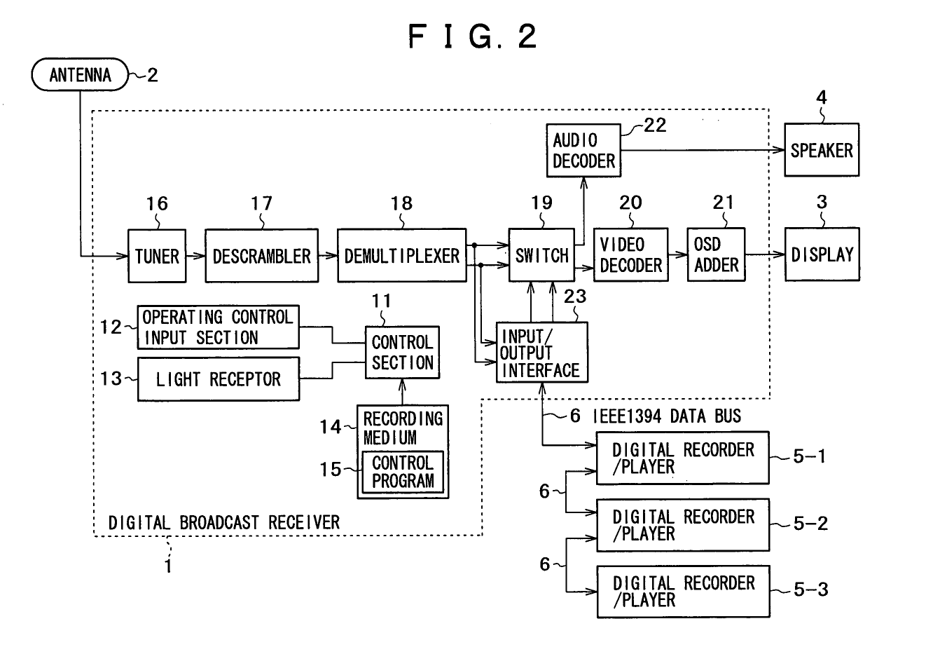

One embodiment of a digital broadcast receiver according to the present invention will now be described with reference to FIG. 2.

The digital broadcast receiver 1 receives and decodes a digital broadcast signal, and then outputs the resulting video signal to a display 3 and the resulting audio signal to a speaker 4. Further, the digital broadcast receiver 1 exchanges decoded video data and audio data with digital recorders/players 5-1 through 5-3, which are connected via an IEEE 1394 data bus 6.The digital broadcast receiver 1 also controls a digital data copy operation that is performed among the digital recorders/players 5-1 through 5-3connected to the IEEE 1394 data bus 6.

A control section 11, which is a component of the digital broadcast receiver 1, controls various components of the digital broadcast receiver 1 when a control program 15 recorded on a recording medium 14 is executed. The control section 11 also controls the components of the digital broadcast receiver 1 in accordance with an operating signal corresponding to a user operation entered from an operating control input section 12 or a light receptor 13. Control lines connecting the control section 11 to the various components are not shown in FIG. 2.

The operating control input section 12 includes operating control buttons that are mounted on an outer surface of the main body. In response to a user operation that is performed in relation to a GUI (Graphical User Interface) appearing on the display 3, the operating control input section 12 outputs a corresponding operating signal to the control section 11. The light receptor 13 receives an operating signal transmitted from a user-operated remote controller (not shown), and relays it to the control section 11.

A tuner 16 extracts a digital broadcast signal from the output of an antenna 2 in accordance with a user-selected station, and outputs the extracted signal to a descrambler 17. The descrambler 17 unscrambles the digital broadcast signal and outputs the unscrambled digital broadcast signal to a demultiplexer (DEMUX) 18. The demultiplexer 18 separates the unscrambled digital broadcast signal into video data and audio data, and outputs them to a switch 19.

The switch 19 outputs the video data and audio data, which are input from the demultiplexer 18 or an input/output interface 23, to a video decoder 20 and an audio decoder 22, respectively.

The video decoder 20 decodes the video data that is input from the switch 19, converts the decoded data to a video signal conforming to the NTSC (National Television System Committee) or other system, and outputs the converted signal to an OSD (On Screen Display) adder 21.

The OSD adder 21 generates a data broadcast video signal, subtitle video signal, GUI video signal, and other signals as needed, superposes the generated signals on the video signal input from the video decoder 20, and outputs the resulting signal combination to the display 3.

The audio decoder 22 generates an audio signal by decoding the audio data input from the switch 19, and then outputs the generated audio signal to the speaker 4.

The input/output interface 23 exchanges video data, audio data, and other digital data with the digital recorders/players 5-1 through 5-3 connected via the IEEE 1394 data bus 6. Further, the input/output interface 23 relays a control signal, output by the control section 11 to control a copy operation among digital recorders/players 5-1 through 5-3, to digital recorders/players 5-1 through 5-3.

Digital recorders/players 5-1 through 5-3 are, for instance, personal computers, television receivers, digital video cameras, hard disk recorders, digital VCRs, digital broadcast receivers, MD players, or other electronic devices that record digital data onto an information recording medium or play back such digital data. The information recording medium may be, for example, a magnetic tape, which does not permit random access, or a hard disk, which permits random access.

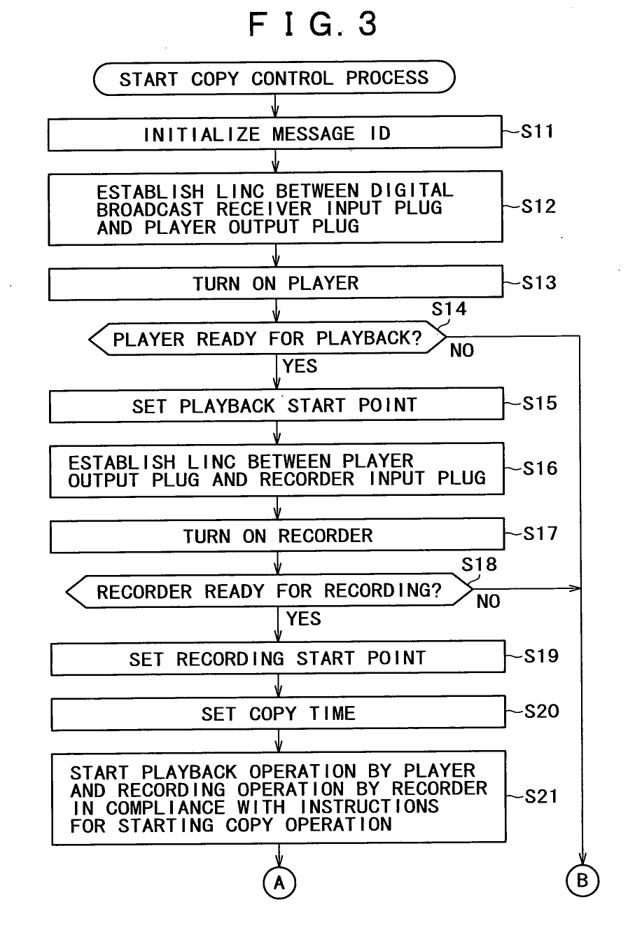

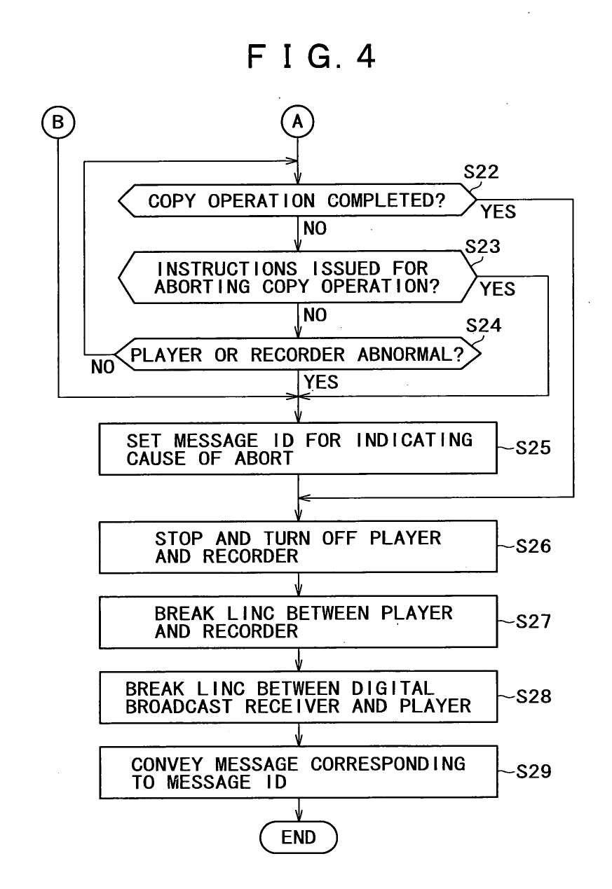

A copy control process performed by the digital broadcast receiver 1 will now be described with reference to the flowcharts in FIGS. 3 and 4. The subsequent description assumes that the digital data played back by the digital recorder/player 5-1 is to be recorded into digital recorder/player 5-2. In the following description, digital recorder/player 5-1 is abbreviated as “player 5-1”, whereas digital recorder/player 5-2 is abbreviated as “recorder 5-2”.

In step S11, the control section 11 initializes a message ID, which identifies the message to be conveyed to the user at the end of the copy control process, to one that indicates a normal end (that is, a successfully performed copy operation).

In step S12, the control section 11 establishes a LINC between the input plug on the digital broadcast receiver 1 and the output plug on the player 5-1. In accordance with the control executed by the control section 11, the switch 19 effects switching so as to output the video data and audio data, which are input from the input/output interface 23, to the video decoder 20 and audio decoder 22, respectively. The video and audio contained in the digital data to be copied can then be monitored on the display 3 and speaker 4 via the digital broadcast receiver 1.

In step S13, the control section 11 checks to ensure that the player 5-1 is turned ON. In step S14, the control section 11 checks whether the player 5-1 is ready for playback. When the player 5-1 is found to be ready for playback, the process proceeds to step S15.

In step S15, the control section 11 sets a playback start point for the player 5-1, that is, the copy start point, in accordance with a user operation. To permit the user to specify the playback start point, the GUI appearing on the display 3 should be provided with operating control buttons such as those for replaying, fast forwarding, rewinding, and seeking. An alternative is to display a list of digital data that can be played back by the player 5-1 and furnish a button for making a digital data selection. If no user operation is performed to specify the playback start point, the current playback head position can be set as the playback start point.

In step S16, the control section 11 establishes a LINC between the output plug on the player 5-1 and the input plug on the recorder 5-2. The digital data played back by the player 5-1 is then input to the recorder 5-2.

In step S17, the control section 11 checks to ensure that the recorder 5-2 is turned ON. In step S18, the control section 11 checks whether the recorder 5-2 is ready for recording. When the recorder 5-2 is found to be ready for recording, the process proceeds to step S19.

In step S19, the control section 11 sets a recording start point for the recorder 5-2, that is, the copy start point, in accordance with a user operation. To permit the user to specify the recording start point, the GUI appearing on the display 3 should be provided with operating control buttons such as those for replaying, fast forwarding, rewinding, and seeking. If no user operation is performed to specify the recording start point, the current recording head position can be set as the recording start point. If the recorder 5-2 uses a random-accessible information recording medium such as a hard disk, the process performed in step S19 can be skipped because digital data is recorded in a free space.

In step S20, the control section 11 sets a copy time (or the amount of data) in accordance with a user operation. To permit the user to specify the copy time, the GUI appearing on the display 3 should be provided, for instance, with an operating control button for setting the copy time. An alternative is to let the control section execute an original function of the recorder 5-1 (e.g., seek function) or reference directory entries, a FAT (File Allocation Table), or the like, to acquire the playback time or an amount of the digital data to be copied.

In step S21, the control section 11 starts a playback operation of the player 5-1 and a recording operation of the recorder 5-2 in response to a user operation performed in relation to a copy start button provided for the GUI. After a copy operation is started, the GUI is provided with a copy abort button.

In step S22 shown in FIG. 4, the control section 11 determines whether the digital data copy operation has been completed by determining whether the copy time selected in the process of step S20 has elapsed (or the selected amount of data has been copied). If the digital data copy operation is found to be incomplete, the process proceeds to step S23. In step S23, the control section 11 checks whether a user operation has been performed to abort the copy operation. If a user operation to abort the copy operation has not been performed, the process proceeds to step S24.

In step S24, the control section 11 checks to determine if either the player 5-1 or recorder 5-2 is abnormal. If it is found that the player 5-1 and recorder 5-2 are both normal, the process returns to step S22 to repeat steps S22 and beyond.

If it is found in step S22 that the digital data copy operation has been completed, the process proceeds to step S26.

In step S26, the control section 11 stops the playback operation of the player 5-1 and the recording operation of the recorder 5-2, and then checks to ensure that the player 5-1 and recorder 5-2 are turned OFF.

In step S27, the control section 11 breaks the LINC between the output plug on the player 5-1 and the input plug on the recorder 5-2. In step S28, the control section 11 breaks the LINC between the input plug on the digital broadcast receiver 1 and the output plug on the player 5-1. In step S29, the OSD adder 21 generates a video signal that presents a message corresponding to the message ID in accordance with the control executed by the control section 11, and outputs the generated video signal to the display 3. The display 3 then shows the message corresponding to the message ID. In the present situation, the message appearing on the display indicates a normal end (e.g., “Copy operation completed”).

If, in step S14, for instance, no information recording medium is set in the player 5-1, the player 5-1 is found to be not ready for playback and the process proceeds to step S25. If, in step S18, for instance, the write-protect tab of a tape medium set in the recorder 5-2 is broken, the recorder is found to be not ready for recording and the process proceeds to step S25.

In step S25, the control section 11 sets a message ID for indicating the occurrence of an abnormality (e.g., “No medium found” in the present situation). Subsequently, processing steps S26 and beyond are performed.

If it is found in step S23 that a procedure for aborting the copy operation has been performed by the user, the process also proceeds to step S25. In this instance, step S25 is performed to set a message ID for indicating an abort (e.g., “Copy operation aborted as specified”).

Even if it is found in step S24 that at least one of the player 5-1 or the recorder 5-2 is abnormal, the process also proceeds to step S25. In this instance, step S25 is performed to set a message ID for indicating an abort (e.g., “Error found in player”). The description of the copy control process performed by the digital broadcast receiver 1 is now completed.

As described above, the copy control process performed by the digital broadcast receiver 1 enables the user to issue instructions for copying digital data by performing a minimum number of operating steps. In this instance, the user does not have to monitor the progress of the copy operation. Further, the GUI indicates the next step to be performed by the user. Therefore, the user can properly issue instructions for making a copy even if the user is not familiar with the operating procedures for the electronic devices being employed.

It should be noted that the present invention can also be applied to a situation where a digital data bus other than an IEEE 1394 data bus is used for the connection between the digital broadcast receiver 1 and digital recorders/players 5-1 through 5-3.

In the present embodiment, the present invention is applied to the digital broadcast receiver 1. However, the present invention can also be applied to electronic devices other than digital broadcast receivers.

In the present description, the steps for writing the program to be recorded on a recording medium include not only processes that are performed in a specified sequence, but also processes that are performed in a parallel manner or individually.

As described above, the present invention makes it possible to copy digital data between digital recorders/players connected to a digital data bus without requiring the user to perform a number of operating steps.

1. A control device for controlling electronic devices connected to a digital data bus, comprising:
a monitoring section for monitoring data output from a first one of the electronic devices connected to the digital data bus;
an association control section for controlling association between the data output from the first electronic device and data input to a second one of the electronic devices connected to the digital data bus;
a start control section for starting a digital data copy process in which data output from the first electronic device is copied to the second electronic device by starting a playback operation of the first electronic device and a recording operation of the second electronic device;
a stop control section for stopping the playback operation of the first electronic device and the recording operation of the second electronic device; and
a notification section for indicating a result of the digital data copy process.

2. The control device according to claim 1, wherein the digital data bus is an IEEE 1394 data bus.

3. The control device according to claim 1, further comprising a detection section for detecting an abnormality in at least one of the first and second electronic devices and aborting the copy process.

4. The control device according to claim 3, wherein said notification section also identifies the abnormality detected by said detection section.

5. A method for controlling electronic devices connected to a digital data bus, comprising:
monitoring data output from a first one of the electronic devices connected to the digital data bus;
controlling an association between the data output from the first electronic device and data input to a second one of the electronic devices connected to the digital data bus;
starting a digital data copy process in which data output from the first electronic device is copied to the second electronic device by starting a playback operation of the first electronic device and a recording operation of the second electronic device;
stopping the playback operation of the first electronic device and the recording operation of the second electronic device; and
indicating a result of the digital data copy process.
